(19) United States
(12) Patent Application Publication
(10) Pub. No.: US 2005/0150609 A1
(43) Pub. Date: Jul. 14, 2005

(54) Adjustable blind structure

(76) Inventor: Chao-Syong Tang, Taichung City (TW)

Correspondence Address: CHARLES E. BAXLEY, ESQ., 90 JOHN STREET, THIRD FLOOR, NEW YORK, NY, 10038, US

(21) Appl. No.: 10/744,473

(22) Filed: Dec. 22, 2003

(51) Int. Cl. E06B 7/086

(52) U.S. Cl. 160/130

(57) ABSTRACT

The present invention discloses an adjustable blind structure, which comprises a rectangular frame, a plurality of rotary shutters disposed in the frame, a link corner rod fixed onto one side of the frame for simultaneously controlling all of the shutters to rotate to a predetermined angle, and a brake structure for controlling the link corner rod to fix into a position in order to set the shutters to the predetermined angle.

### BACKGROUND OF THE INVENTION

1. Field of the Invention

The present invention relates to blind structures, more particularly to a structure applied to an object such as a partition, a blind, and a furniture door panel, and its main body comprises a plurality of movable shutters in a frame, and users can use both ends of the blind structure as the rotary axis to turn and fix the shutters to a predetermined angle.

2. Description of the Related Art

In general, partitions, blinds, and furniture door panels may adopt a shuttered structure, and the shutters can either be fixed or movable. The fixed shutters are generally designed with a slightly inclined angle and an equidistant gap between every two shutters. The movable shutters allow users to open and shut the shutters on their own. Of course, the movable shutter structure can meet our requirements better.

The inventor believes that a practical design for the control of opening or shutting or positioning the aforementioned shutters should comply with the following conditions:
1. A predetermined number of shutters should be used to give consistent opening and shutting movements, and the opened shutters can be set to a fixed position.
2. The structure for controlling the shutters to open, shut, or be set into a fixed position should be simple and easy-to-install. We should avoid using a very complicated control structure, which will greatly increase the cost of the product, and also avoid using a protruded or bulky structure which will make the storage and packaging of the product difficult.

### SUMMARY OF THE INVENTION

The primary objective of the present invention is to provide an adjustable blind structure, which is a solution with the detailed design for the movable shutters of the blind structure. Such design allows the shutters to have consistent opening and shutting movements, and the opened shutters to be fixed at a predetermined angle.

Another objective of the present invention is to provide an adjustable blind structure, which is designed to simplify the structure for the control of opening, shutting, and setting the shutters in a fixed position, so the product can be stored, packaged, and transported more easily, and it also can make the assembling process simpler and easier.

The technical measure taken to achieve the foregoing objectives is described as follows.

An adjustable blind structure comprises:
a rectangular frame;
a plurality of shutters disposed in the frame, each shutter having one end fixed to a twig and the other end to an adjusting bolt, and the other ends of the twig and the adjusting bolt being pivotally coupled to the corresponding sides of the frame, and the a circular latch being disposed along the radial direction on outer periphery of the adjustable bolt;
a link corner rod having a cross section substantially in the shape of a L-shaped rod, and passing at least one fixture through a long perforation disposed on the frame proximate a side of the foregoing circular latch; and a latch groove being disposed at the corresponding side of the circular latch for embedding the circular latches one by one;
a brake structure, comprising at least two brake grooves successively disposed at the outer periphery and a hook rod pivotally coupled to a position corresponding to the frame, such that one end of the hook rod being latched into one of the brake grooves to fix the link corner rod and the other end for being used for user's control.

### BRIEF DESCRIPTION OF THE DRAWINGS

Other features and advantages of the present invention will become apparent in the following detailed description of the preferred embodiments with reference to the accompanying drawings, in which:

FIG. 1 is a perspective view of the blind structure according to the present invention.

FIG. 2 is a view of the disassembled parts of the blind structure according to the present invention.

FIG. 3 is a perspective view of the assembled blind structure according to the present invention.

FIG. 4 is a perspective view of the brake structure according to the present invention.

FIG. 5 is a planar view of the brake structure showing its movements according to the present invention.

FIG. 6A is a planar view of part of the shutters set in the vertical position according to the present invention.

FIG. 6B is a cross-sectional view of the section along the direction 6B-6B as depicted in FIG. 6A.

FIG. 7A is a planar view of part of the shutters being partially opened according to the present invention.

FIG. 7B is a cross-sectional view of the section along the direction 7B-7B as depicted in FIG. 7A.

FIG. 8A is a planar view of part of the shutters being fully opened according to the present invention.

FIG. 8B is a cross-sectional view of the section along the direction 8B-8B as depicted in FIG. 8A.

### DETAILED DESCRIPTION OF THE PREFERRED EMBODIMENTS

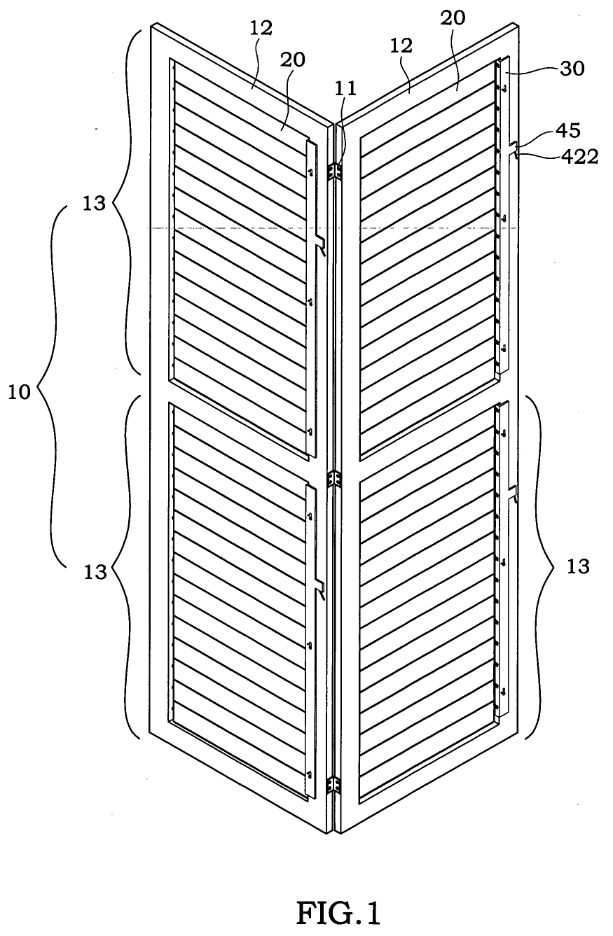

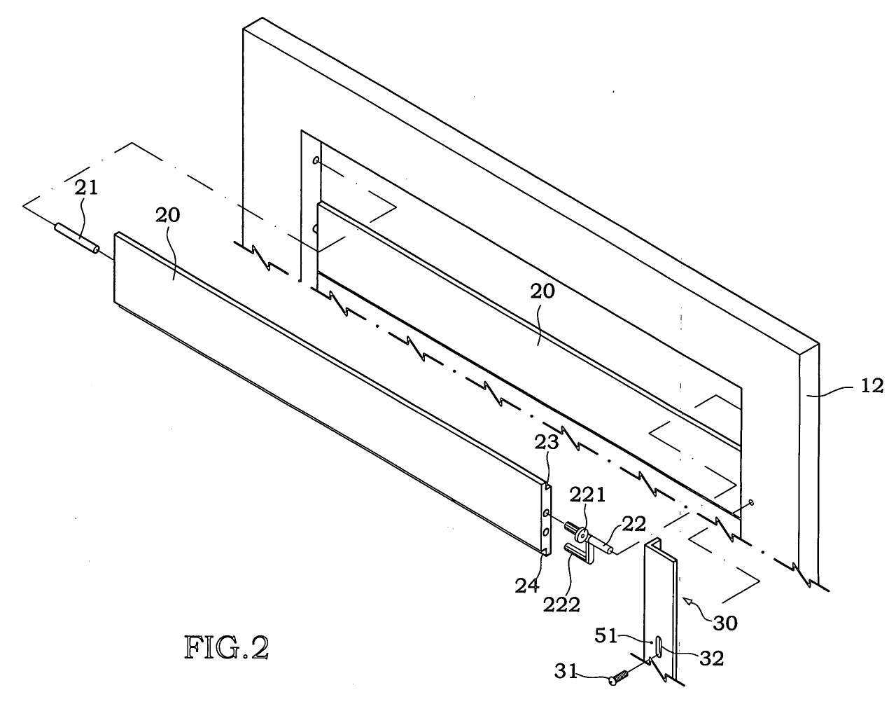

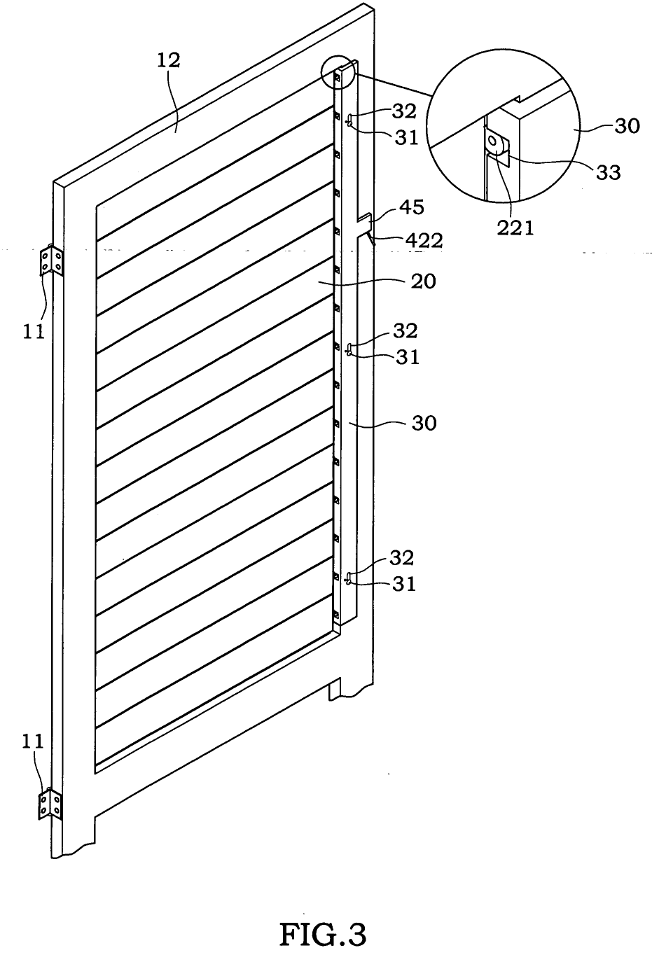

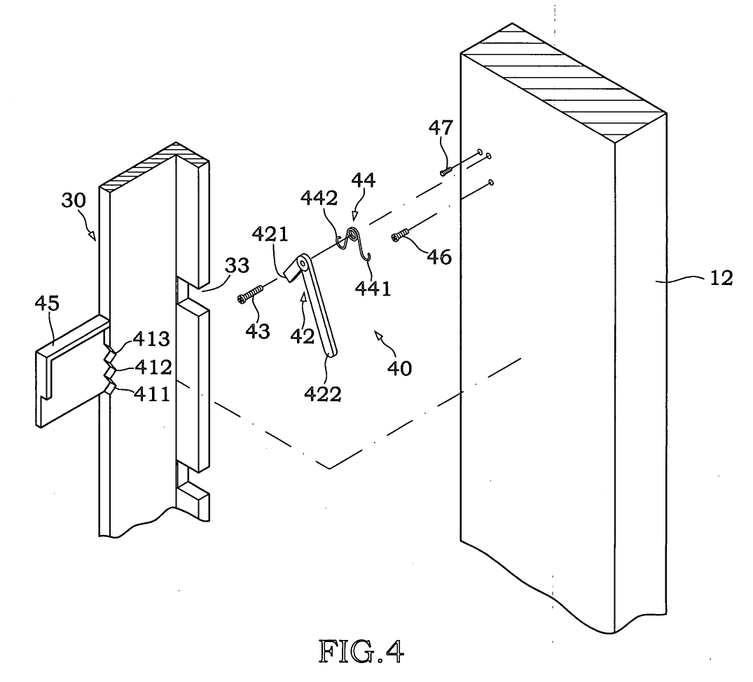

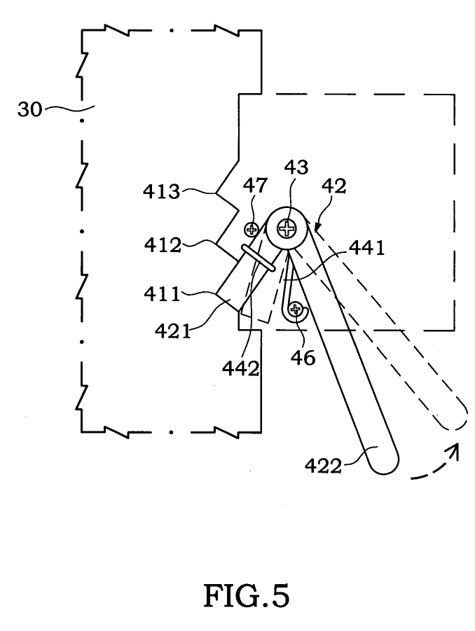

Please refer to FIG. 1 for the adjustable blind structure according to a preferred embodiment of the present invention. The figure illustrates the blind structure and the technology to control the shutters of the blind. The blind structure comprises at least two blind units 10 coupled by a hinge 11, each blind unit 10 having a frame 12, and at least two blind structures 13 can be divided in the space within the frame 12 according to the height of the blind unit 10, and the blind structure 13 comprising:
a plurality of transversally aligned shutters 20 as shown in FIG. 2, each shutter having a twig 21 at one end and an adjusting bolt 22 at the other end, and the twig 21 and adjusting bolt 22 passing and pivotally fixing one of their ends on both left and right sides of the shutter 20 at a position about one-third from the top, and the other end pivotally coupled to the corresponding surfaces on both sides, an attaching edge disposed individually at the top and the bottom of each shutter, so that when every shutter is in the vertical position, the upper attaching edge 23 of a shutter at a lower position is attached to the lower attaching edge 24 of a shutter at a higher position in order to get rid of the bad look of the gap and keep the surface even, a circular latch 221 being extended from the outer edge of a bolt rod of the adjusting bolt 22 along the same radial direction as the front side of the shutter 20, a secondary bolt rod 222 is disposed at an end of the shutter 20, and the open end of the secondary bolt rod 222 passes into an end of the shutter 20 to prevent the adjusting bolt 22 from running idle in the shutter 20;
a link corner rod 30 as shown in FIGS. 2, 3, and 4 being a L-shaped rod structure, having a plurality of fixtures 31 such as screws to pass through a plurality of long perforation 32 and then onto the frame 12 next to the foregoing circular latch 221, and a plurality of open latch grooves 33 disposed on the inner side of the frame 12 for embedding the circular latches 221 therein one by one;
a brake structure 40 as shown in FIGS. 4 and 5 comprising a plurality of brake grooves 411, 412, 413 successively disposed on the outer side of the link corner rod 30 and a hook rod 42 movably coupled to the corresponding position on the frame 12, and the bent section of the hook rod 42 allowing a component 43 and a torque spring 44 to pass through, and the component 43 being fixed onto the frame 12, and the hook rod 42 rotating about the component 43, and its short end 421 being latched into the predetermined position of one of the brake grooves 411, 412, 413, and its long end 422 being used for user's control; one spring leg 422 of the spring 44 being hooked into a fixture 46 on the frame 12, and the other spring leg 442 being hooked into the short end 421 of the hook rod 42, such that the elasticity of the spring 44 provides the force for the hook rod 42 to press against one of the brake grooves 411, 412, 413 and slightly turns the long end 422 counterclockwise to drive the short end 421 to produce a counterclockwise swing along the circumference and being separated from the brake groove 411, 412, 413; further the short end 421 of the hook rod 42 being latched into a predetermined position of one of the brake grooves 411, 412, 413; a stop component 47 being disposed on the frame 12 adjacent to the edge of the short end 421, and the stop component 47 being a screw locked onto the frame 12 for stopping the counterclockwise rotation of the whole hook rod 42. A shade 45 is disposed at the position of the link corner rod 30 at a position corresponding to the brake groove 411, 412, 413 to cover the brake groove 41 and part of the hook rod 42 to make the involved portion look better, and the long end 422 of the hook rod 42 is extended outside the shade 45 to let users to control the rod.

By means of the foregoing structure, the shutter 20 can be controlled by the user to a vertical closed state, a partially opened state (shutter inclines at an angle of about 35˜45 degrees) or fully opened state (shutter inclines at an angle of about 70˜80 degrees).

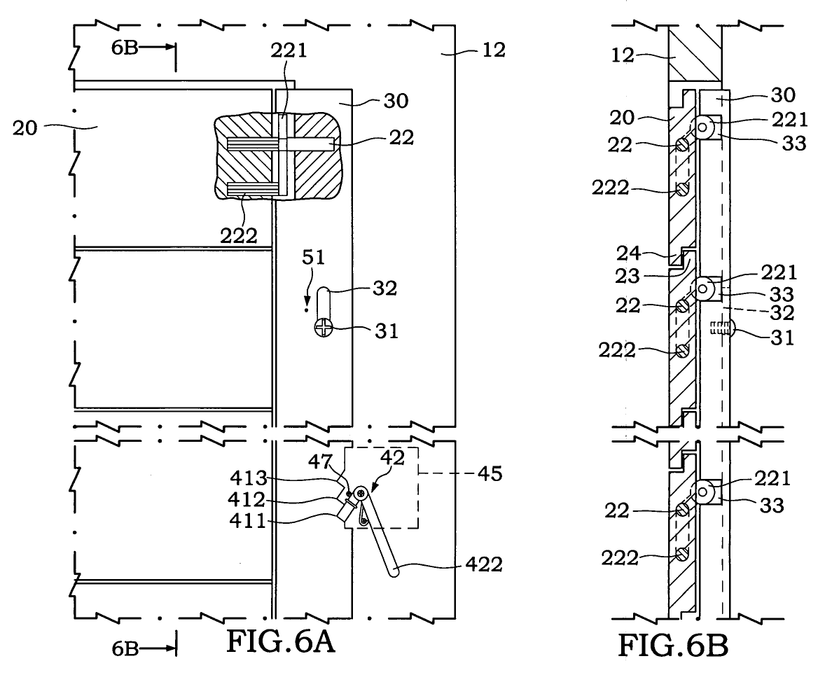

Please refer to FIGS. 6A and 6B for the vertical partially opened shutters. Each shutter 20 is in vertical position, and the upper edge 23 of one shutter 20 is overlapped with the lower attaching edge 24 of the other shutter 20. The fixture 31 of the link corner rod 30 is located at the bottom of the long perforation 32, and the short end of the hook rod 42 is latched at the lowest brake groove 411.

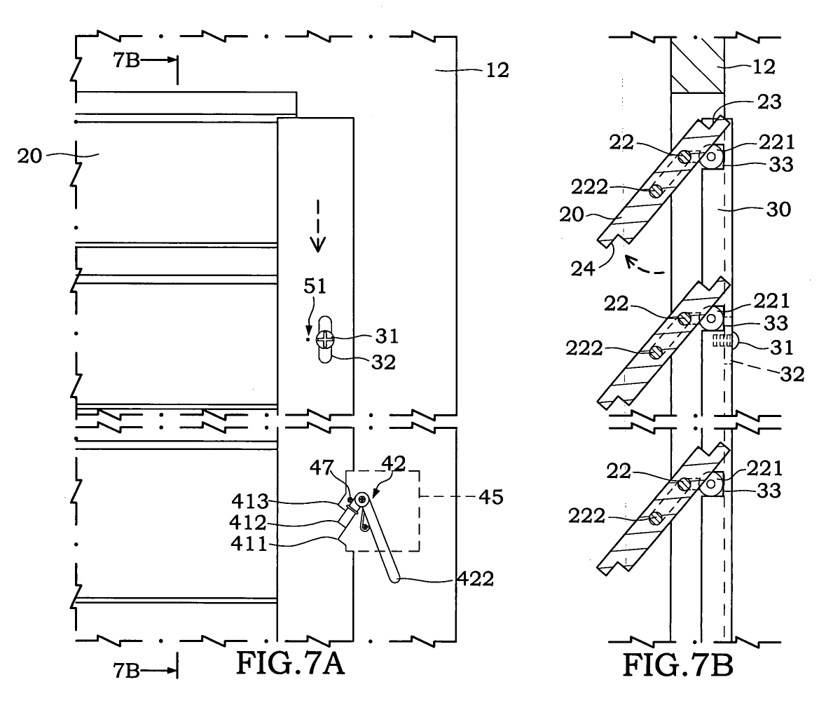

Please refer to FIGS. 7A and 7B for the partially opened shutter. Firstly, a user uses one hand to turn the long end 422 of the hook rod 42 outward in the clockwise direction, such that the short end 421 will be separated from the brake groove 411 and the link corner rod 30 is in a state free from the latch. Then, the user uses another hand to control the link corner rod 30 to move it down slightly until the fixture 31 is located at the position about the middle of the long perforation 32. The downwardly moving link corner rod 30 and its latch groove 33 drive the circular latch 221 to turn clockwise direction along the radial direction to a predetermined angle, and also drive the adjusting bolt 22 to turn clockwise to a predetermined angle and the shutter 20 to a partially opened state with an inclination of 35˜45 degrees. Then, the user can release the hook rod 42, so that the resilience of the spring 44 drives the hook rod 412 to resume its original position and its short end 421 to be latched into the brake groove 412 in the middle. The link corner rod 30 is latched and fixed by the hook rod 42, and the latch groove 33 is used to fix all circular latches 221 to the current positions, so that the shutter 20 is partially opened and inclined at a predetermined angle.

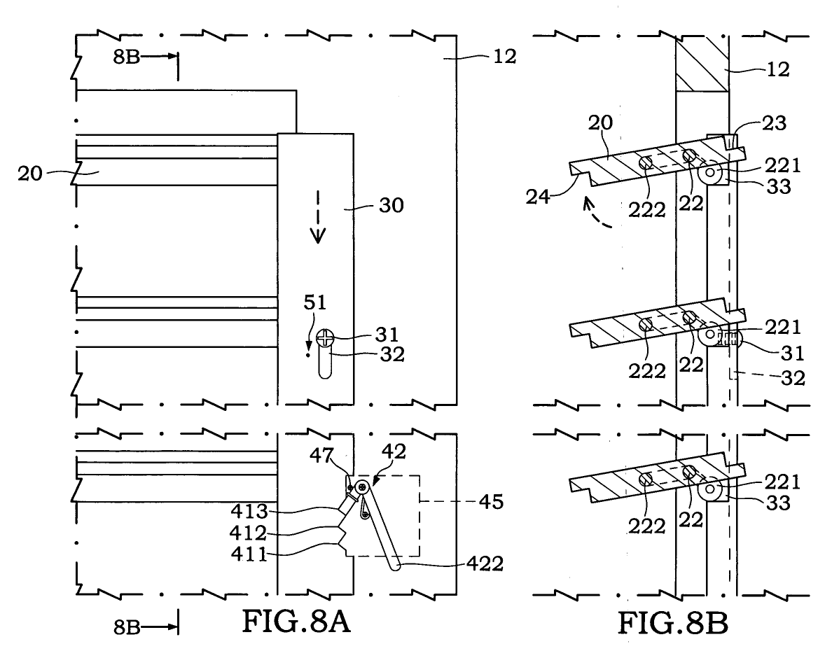

Please refer to FIGS. 8A and 8B for the fully opened shutter. The operation is similar to that as described above, except the distance required to control the link corner rod 30 to move downward is increased until the fixture 31 is located at the top of the long perforation 32 in order to drive the link corner rod 30 to move down and all shutters simultaneously rotate to an angle of about 70˜80 degrees which is larger than that of the partially opened shutters. Further, when the hook rod 42 resumes its position, the short end 421 is latched into brake groove 413 at the top, so that the shutter 20 will be in the fully opened position and inclined at a predetermined angle.

Further, since the twig 21 and the adjusting bolt 22 pass through both sides of the shutter 20 at a position of about one-third of the whole length from the top of the frame 12. Therefore, when the shutter 20 is inclined, the lower edge of the shutter 20 produces a vertical action to resume its position due to the gravitational force, the action will concentrate on the link corner rod 30, so that the link corner rod 30 will produce an upward force to resume its position. However, since the hook rod 42 is stopped by the stopping component 47 and can no longer push and turn the link corner rod 30 to resume its position, therefore the hook rod 42 will stop the link corner rod 30 and keep it at a predetermined position. If the user turns the long end 422 of the hook rod 42 outward, the short end 421 will be separated from the brake groove 412, 413, and when the link corner rod 30 is free from the latch state, all shutters 20 will be turned to a vertical position due to the gravitational force, and thus pushing the link corner rod 30 upward.

To facilitate users to control the moving distance of the link corner rod 30, particularly when the shutters are in the partially opened state that requires more accurate control of the link corner rod 30 to latch the hook rod 42 into the groove 412 in the middle, a floating mark 1 is added to the surface of the link corner rod 30 at the edge of the long perforation 32. The center of the fixture 31 is used as a fixing mark. When the shutter 20 is turned into the partially opened state, the floating mark 51 will align horizontally with the fixture 31 and thus serving as a visual reference for users to release the hook rod 42 at such relative position in order to automatically return the hook rod 42 to latch into the center of the brake groove 412. When the shutter 20 is closed or fully opened, the long perforation 32 uses the top and bottom of the hole to press against the fixture 31, so that the user can know the current opened or closed condition of the shutter, and then the hook rod 42 can be latched successfully into the brake groove 413, 412 at the upper position or the lower position.

The present invention controls the shutter in a vertical closed state, a partially opened state (the shutter is inclined at 35˜45 degrees) or a fully opened state (the shutter is inclined at 70˜80 degrees) and restricts the shutter 20 at a predetermined angle. The control for opening or closing the shutter 20 and the positioning structure are also very simple, which can lower the level of difficulty for the assembling and reduce manpower and manufacturing costs. The plate structure of the shutter makes the storage, packaging, and transportation of the product very easy.

While the present invention has been described by the most practical and preferred embodiments, it is understood that this invention is not limited to the disclosed embodiments but is intended to cover various arrangements included within the spirit and scope of the broadest interpretations and equivalent arrangements.

1. An adjustable blind structure, comprising:
a frame, substantially in a rectangular shape;
a plurality of shutters, disposed inside said frame, each shutter having both sides movably coupled to two corresponding edges of said frame;
a link corner rod, disposed on said frame, for controlling and simultaneously rotating said shutters to a predetermined angle by using both ends as fulcrums; and
a brake structure, disposed on said frame, for controlling said link corner rod to fix each shutter at a predetermined angle.

2. The adjustable blind structure of claim 1, wherein said shutter comprises a twig at one end and an adjusting bolt at the other end, and the other ends of said twig and adjusting bolt are movably coupled to the corresponding edges of said frame.

3. The adjustable blind structure of claim 2, wherein said twig and adjusting bolt pass through and are fixed onto both ends of said shutter at a position substantially one third from the top.

4. The adjustable blind structure of claim 2, wherein said adjusting bolt comprises a secondary bolt rod bent from the outer edge of the rod of said adjusting bolt, and the open end of said secondary bolt rod passes into an end of said shutter.

5. The adjustable blind structure of claim 2, wherein said adjusting bolt comprises a circular latch protruded from the periphery of said bolt rod, and said link corner rod simultaneously drives all circular latches of said shutter, so that each shutter rotates to a predetermined angle by using both ends as fulcrums.

6. The adjustable blind structure of claim 5, wherein said link corner rod is a rod structure with a L-shape cross section, and at least one fixture passes through a long perforation disposed on the edge of said frame proximate said circular latch, and a latch groove is disposed on the edge corresponding to said circular latch for embedding said circular latches one by one.

7. The adjustable blind structure of claim 6, wherein said link corner rod on its surface by the edge of said long perforation comprises a floating mark, and the center of said fixture is used as a positioning mark, so that when said shutter rotates to a predetermined angle, said floating mark is aligned horizontally with the center of said fixture.

8. The adjustable blind structure of claim 1, wherein said brake structure comprises at least two brake grooves successively disposed on said link corner rod and a hook rod being movably coupled to the corresponding position of said frame, and one end of said hook rod is latched into one of said brake groove to restrict said link corner rod, and the other end is used by a user for controlling said link corner rod.

9. The adjustable blind structure of claim 8, wherein said frame comprises a stopping component at a position proximate said hook rod such that said hook rod resists the action for said hook rod to resume its position.

10. The adjustable blind structure of claim 8, wherein said link corner rod comprises a shade disposed at a position corresponding to said brake groove, and the end of the hook rod for user's control extends out from said shade.

11. The adjustable blind structure of claim 8, wherein said spring provides said hook rod a normal force to press against said brake groove.

12. The adjustable blind structure of claim 11, wherein said spring is a torque spring, pivotally coupled to said hook rod, and one spring leg is fixed to an edge of said frame, and the other spring leg fixed to said hook rod latches an end of said latch groove.

13. The adjustable blind structure of claim 1, wherein said each shutter has an attaching edge on its upper and lower edges.

14. An adjustable blind structure, comprising:
a frame, substantially in a rectangular shape;
a plurality of shutters, disposed in said frame, each shutter having one end fixed to a twig and the other end to an adjusting bolt, and the other ends of said twig and said adjusting bolt being pivotally coupled to the corresponding sides of said frame, and the a circular latch being disposed along the radial direction on outer periphery of the adjustable bolt;
a link corner rod, having a cross-section substantially in the shape of a L-shaped rod, and passing at least one fixture through a long perforation disposed on said frame proximate a side of said circular latch; and a latch groove being disposed at the corresponding side of said circular latch for embedding said circular latches one by one;
a brake structure, comprising at least two brake grooves successively disposed at the outer periphery of said brake groove and a hook rod pivotally coupled to
a position corresponding to said frame, such that one end of said hook rod being latched into one of said brake grooves to fix said link corner rod and the other end for being used for user's control.

15. The adjustable blind structure of claim 14, wherein said adjusting bolt comprises a secondary bolt rod bent from the outer edge of the rod of said adjusting bolt, and the open end of said secondary bolt rod passes into an end of said shutter.

16. The adjustable blind structure of claim 14 further comprising a spring for providing said hook rod a normal force to press against said brake groove.

17. The adjustable blind structure of claim 14 further comprising a shade disposed at a position corresponding to said brake groove, so that said hook rod resists the action of said link corner rod to resume its position.

18. The adjustable blind structure of claim 14, wherein said link corner rod comprises a shade disposed at a position corresponding to said brake groove, and the end of said hook rod for user's control is extended out from said shade.

19. The adjustable blind structure of claim 14, wherein said each shutter has an attaching edge on its upper and lower edges.

20. The adjustable blind structure of claim 14, wherein said link corner rod on its surface by the edge of said long perforation comprises a floating mark, and the center of said fixture is used as a positioning mark, so that when said shutter rotates to a predetermined angle, said floating mark is aligned horizontally with the center of said fixture.
